(19) United States
(12) Patent Application Publication
(10) Pub. No.: US 2004/0083231 A1
(43) Pub. Date: Apr. 29, 2004

(54) Management of information relating to construction industry products

(76) Inventors: Robert J. Boros, Maplewood, MN (US); Kristen Ann Jensen, St. Paul, MN (US)

Correspondence Address: 3M INNOVATIVE PROPERTIES COMPANY, PO BOX 33427, ST. PAUL, MN, 55133-3427, US

(21) Appl. No.: 10/281,383

(22) Filed: Oct. 24, 2002

(51) Int. Cl. G06F 17/00; G06F 7/00

(52) U.S. Cl. 707/104.1

(57) ABSTRACT

A system for management of construction product information, and delivery of the product information to users via a computer network includes an electronic archive and a user interface. The electronic archive stores product information for one or more construction products, which may include technical information and regulatory approval information, and may take the form of documents stored within files in the archive. The user interface contains links to the product information. The system permits users, which may be customer service representatives associated with technical service or sales departments of an enterprise that manufactures and/or sells the products, to access the product information via the links in the user interface. The system may also include a network server that contains the electronic archive and network clients associated with the users that presents the user interface to the users. The network server may deliver product information to the network clients via a network, and the links may define network locations for the product information. The customer service representatives may also interact with the network server to manage contact information and correspondence, and to receive announcements via the network.

### TECHNICAL FIELD

The invention relates to information management and, more particularly, to organization and presentation of information relating to construction industry products.

### BACKGROUND

Business enterprises typically generate technical information relating to products manufactured or sold by the enterprise. The technical information may include specifications, use or installation instructions, application and design notes, and the like. The information often takes the form of various books, pamphlets, flyers, or other types of product literature. Customer service representatives within the technical service or sales departments of an enterprise may use the information internally for reference purposes, or provide the information to customers.

An enterprise may also receive and maintain regulatory approval information, such as test results and regulatory approval letters. The regulatory approval information may include information that describes the standards and regulations that apply to particular products. As an illustration, construction products, such as concrete, structural, electrical, lighting, plumbing, insulation, HVAC, telecommunications, or fire protection products are subject to a variety of regulations including performance and safety standards established by Underwriters Laboratories, Inc. (UL). In addition, use of construction products in buildings is carefully regulated by various governmental or quasi-governmental regulatory entities.

An enterprise may submit products to testing to determine compliance with applicable standards. The result of the testing may be used by a regulatory entity to determine whether to grant regulatory approval to the product. Customer service representatives may also use regulatory approval information internally as reference information. In addition, compliance of a product with standards and regulations may be of critical importance to the customer in making a purchasing decision. Therefore, the enterprise may provide customers with documentation of the results of regulatory tests and approvals, as well as information that describes the standards and regulations themselves.

Customer service representatives within a technical services department may use technical information and regulatory approval information to provide customers with engineering judgments, i.e., opinions as to the proper usage of products within an application described by the customer in light of applicable standards and regulations. Typically, in such cases, the technical service department receives information from the customer describing a proposed construction application. Technical services representatives then use the information provided by the customer, regulatory approval information, and technical information to recommend a proper course of action for the customer.

The amount of technical and regulatory approval information can be quite large. Because these types of information may be generated and received by different departments of the enterprise, the entire body of information may not be co-located. Instead, the information can be dispersed throughout the enterprise. Further, the information can change rapidly. Often, redundant subsets of some of the information are maintained by individual employees.

The breadth and decentralized nature of the information can make it difficult and time consuming for customer service representatives to interact with the customers to locate or retrieve product information to provide to the customers. The breadth and decentralized nature of the information is particularly problematic for technical service representatives, who must locate and retrieve several types of information, as described above, in order to provide customers with engineering judgments. Ultimately, the time that customer service representatives spend locating and retrieving information is a cost borne by the enterprise, and may result in undesirable delays in providing information or engineering judgments to customers.

Further, customer service representatives may not be aware of changes to a product specification, or new testing or regulatory approval information until they receive and read hard copies of the changed specification, test results, or approval documents, and, for example, update an appropriate hard copy binder. In such situations, the enterprise may be providing customers with obsolete or inconsistent information to the extent that various customer service representatives possess differing information sets. Importantly, engineering judgments provided by the enterprise may be incorrect if they are based on stale information, and inconsistent if they are based on differing information sets possessed by the various technical service representatives.

### SUMMARY

In general, the invention is directed to management of construction product information, and delivery of the product information to users via a computer network. The product information may take the form of technical documents or regulatory approval documents relating to products manufactured and/or sold by an enterprise. These documents may be centrally stored within files stored in a file archive.

The users may access this technical information and regulatory approval information via links to the information provided by a user interface that is presented to the users. Information that describes the documents within the file archive may be maintained in a database, and may be used to allow customer service representatives and customers to locate documents using menus, indexes, and tables of contents provided by the network server via the network clients. The users may interact with a network server in order to retrieve information contained in the files via the network. The user interface may include a graphical user interface or web browser operating on network clients associated with the users. The users may be customer service representatives associated with technical service or sales departments of the enterprise.

Customer service representatives may also interact with the network server in order to manage contact information and correspondence, and to receive enterprise announcements. In addition, customer service representatives may use a combination of technical information, regulatory approval information and contact information to formulate engineering judgments for particular construction products manufactured or sold by the enterprise, and deliver the engineering judgments as correspondence to a customer.

In one embodiment, the invention is directed to a method that comprises storing technical information and regulatory approval information for one or more construction products in an electronic archive. The method further comprises presenting a user interface containing links to the technical information and the regulatory approval information, and permitting a user to access the technical information and the regulatory approval information via the links in the user interface. The electronic archive may reside on a network server, and the links may define network locations for the technical information and regulatory approval information. The method may comprise permitting multiple users to access the technical information and regulatory approval information via a network.

In another embodiment, the invention is directed to a system that includes an electronic archive and a user interface. The electronic archive stores technical information and regulatory approval information for one or more construction products. The user interface contains links to the technical information and regulatory approval information. The system may also include a network server that contains the electronic archive and a network client that presents the user interface. The network server may deliver technical information and regulatory approval information to the network client via a network, and the links may define network locations for the technical information and regulatory approval information.

In another embodiment, the invention is directed to a computer-readable medium containing instructions. The instructions cause a programmable processor to present a user interface containing links to technical information and regulatory approval information relating to construction products stored in an electronic archive. The instructions also cause the processor to permit a user to access the technical information and the regulatory approval information via the links in the user interface. The electronic archive may reside on a network server, and the links may define network locations for the technical information and regulatory approval information. The medium may further include instructions that cause the processor to permit multiple users to access the technical information and regulatory approval information via a network.

The invention may be capable of providing one or more advantages. For example, by storing documents that contain product information centrally in a file archive, the invention may reduce the difficulty and time associated with locating and retrieving the documents, thereby promoting customer and customer service representative convenience and efficiency. This advantage may be realized where, for example, the product information pertains to construction products, for which an enterprise generates technical documents and receives regulatory approval documents. This advantage may be particularly evident where technical services representatives need to locate and retrieve both technical and regulatory approval documents in order to provide customers with engineering judgments. In some embodiments, customers may be provided with direct access to the documents on a self-service basis, offering added convenience to customers and reducing the burden on enterprise customer service representatives. Additionally, the central storage of such documents advantageously allow delivery of more current product information to employees and customers, and may be used to ensure that customer service representatives and customers receive consistent product information by virtue of accessing a single information set.

Moreover, the way in which such documents within the file archive are organized and presented to customer service representatives and customers may further reduce the time and difficulty involved in locating and retrieving such documents. For example, information describing the documents stored in the file archive may be stored in a database and used to allow customer service representatives and customers locate documents. Menus, indexes, or tables of contents may be provided that enable customer service representatives and customers to more quickly and easily locate and retrieve documents. Further, administrators may organize documents within files such that a particular document within the file may be more quickly and easily located.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system for management of construction product information, and delivery of the product information via a computer network.

FIG. 2 is a block diagram illustrating the system of FIG. 1. in greater detail.

FIG. 3 is a flow diagram illustrating an example method of providing product information to customer service representatives and customers.

FIG. 4 is a flow diagram illustrating an example method for managing contact information for customer service representatives.

FIG. 5 is a flow diagram illustrating an example method for managing correspondence for customer service representatives.

FIG. 6 is a flow diagram further illustrating the example method for managing correspondence of FIG. 5.

FIG. 7 is a flow diagram illustrating an example method for delivering announcements to customer service representatives.

FIG. 8 is a flow diagram illustrating an example method by which a technical service representative may generate an engineering judgment.

FIG. 9 is a block diagram further illustrating the system of FIG. 1.

FIG. 10 is a flow diagram illustrating a method for synchronizing archives and databases.

### DETAILED DESCRIPTION

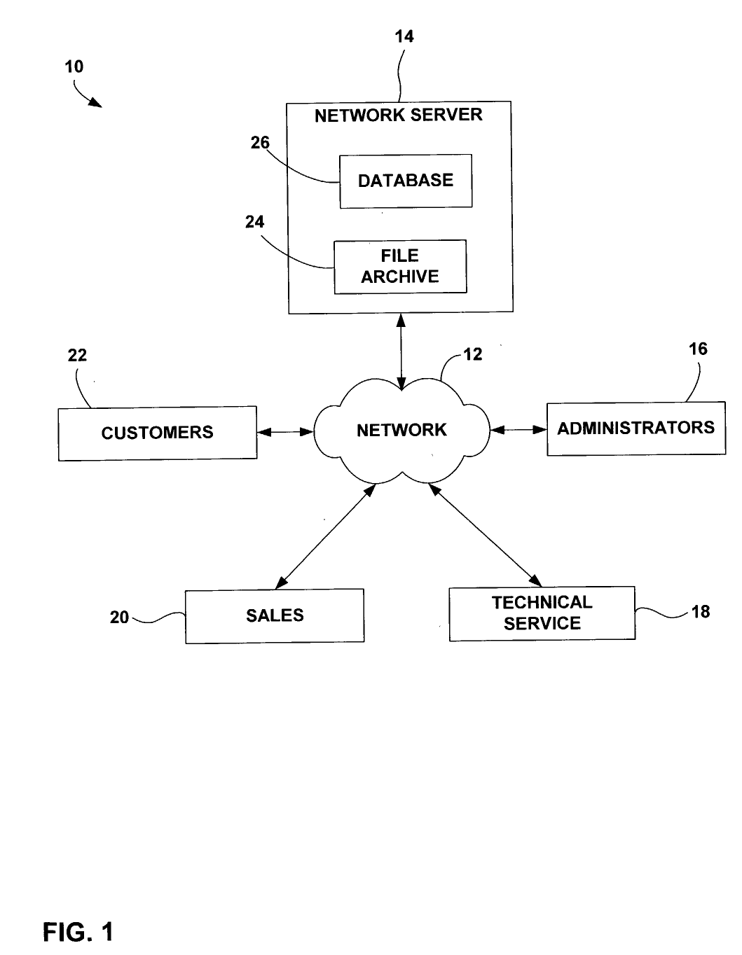

FIG. 1 is a block diagram illustrating an example system 10 for management of construction product information, and providing the product information via a computer network 12. Computer network 12 may take the form of a LAN, WAN, or a global computer network such as the World Wide Web. As shown in FIG. 1, system 10 may include a network server 14 coupled via network 12 to a number of network client devices associated with administrators 16, technical services representatives 18, sales representatives 20 and customers 22. As shown in FIG. 1, network server 14 may contain an electronic file archive 24 and a database 26.

Administrators 16, technical service representatives 18, sales representatives 20 and customers 22 are users (collectively “users 16-22”) of system 10. Administrators 16 may take the form of individuals or a department within an enterprise that administer system 10 for other users, and maintain the product information within file archive 24, which will be described in greater detail below. Technical services representatives 18 may take the form of employees of the enterprise who provide technical support to customers 22 related to the products that the enterprise manufactures and/or sells. For example, technical service representatives 18 may provide engineering judgments to customers 22. Sales representatives 20 may take the form of employees of the enterprise who sell the products that the enterprise manufactures and/or sells to customers 22. Customers 22 are individuals or entities that have or may purchase the products that the enterprise manufactures and/or sells. System 10 may include additional users (not shown) such as distributors, marketing employees, engineers, individuals within a regulatory compliance department, individuals within management of the enterprise, and the like.

System 10 may provide the product information stored in file archive 24 to technical service representatives 18, sales representatives 20, customers 22, and any such additional users. System 10 may also manage contact information and correspondence for, and provide announcements to technical service representatives 18, sales representatives 20, and such additional network clients, as will be described below. Technical service representatives 18 may use system 10 to provide engineering judgments to customers 22 by retrieving a combination of technical information and regulatory approval information to formulate engineering judgments for particular construction products manufactured or sold by the enterprise, and to deliver the engineering judgments as correspondence to a customer.

The network client devices (not shown) associated with administrators 16, technical service representatives 18, sales representatives 20 and customers 22 may take the form of a variety of devices that permit a users 16-22 to access resources on network 12. Examples of suitable network clients include desktop and portable personal computers, PDAs, Internet-equipped wireless telephones, and other Internet appliances operating in a Windows, Macintosh, Unix, Linux, Palm, Windows CE, or similar operating system environment. Each network client includes a processor (not shown) and memory (not shown), which may include any fixed or removable magnetic or optical computer-readable media, such as magnetic tapes, magnetic disks, or optical disks. Each network client may also include input devices, such as a keyboard and a pointing device, a display device such as a cathode ray tube (CRT) monitor or flat panel display, and a printer. Each of the network clients may, for example, connect to network 12 via a network connection, dial-up connection, wireless connection, or the like.

Each network client may execute instructions embodied in application software to interact with and access resources provided by network server 14. The instructions may cause the processor to present users 16-22 with a user interface. The user interface may allow administrators 16 to administer system 10 for technical service representatives 18, sales representatives 20 and customers 22. The user interface may allow the technical service representatives 18, sales representatives 20 and customers 22 to interact with network server 14 to retrieve product information stored in file archive 24. Further, the user interface may allow technical service representatives 18 and sales representatives 20 (collectively “customer service representatives 18,20”) to interact with network server 14 to manage contact information and correspondence, and receive announcements, as will be described below. The instructions may also include a number of commercial application software packages, such as postscript data file viewing, word processing, email, and web browser software packages that are provided to users 16-22 via the user interface.

The user interface may be presented as a graphical user interface (GUI). The user interface may be presented as a series of web pages via a web browser. Users 16-22 may interact with network server 14 by highlighting and selecting various links or icons, making selections within menus such as drop down menus, or entering text in text boxes within the user interface. The user interface may provide users 16-22 with links to technical information and regulatory approval information stored in file archive 24. The user interface may present a graphical depiction of a desktop to users 16-22, and depict the links as books located on the desktop. The user interface may also provide these links to the product information via tables of contents, menus, indexes, and the like.

Network server 14 may include one or more computing devices including one or more processors that cooperate to provide the functionality described herein. In addition, network server 14 may execute a variety of software applications that interact with software processes running on different machines to provide the functionality described herein. The software applications executed by network server 14 may be stored in fixed or removable magnetic or optical computer-readable media, such as magnetic tapes, magnetic disks, or optical disks. For example, network server 14 may execute programs that allow it to interact with network clients 16-22 via a user interface provided by network client devices and network 12. In some embodiments, network server may include at least one of a file server (not shown) to interact with file archive 24, a database server (not shown) to interact with database 26, and a web server (not shown) to provide the user interface and serve files stored in file archive 24 to technical service representatives 18, sales representatives 20, and customers 22 as web pages.

As mentioned above, network server 14 interacts with network clients associated with technical service representatives 18, sales representatives 20, and customers 22 to provide these users with construction product information that is stored in file archive 24 via network 12. The product information may include technical information, such as product specifications and product use and installation instructions, application and design notes, and the like, and regulatory approval information, such as test results and approval letters received by the enterprise, and information maintained by the enterprise that describes the standards and regulations that apply to products that the enterprise manufactures and/or sells. The product information may also include other types of information, such as marketing information. The product information may take the form of documents generated or received by the enterprise. Administrators 16 may direct network server 14 to store files containing one or more such documents in file archive 24 for later retrieval by technical service representatives 18, sales representatives 20, and customers 22.

By the storing the documents that contain product information centrally in file archive 24, system 10 may reduce the difficulty and time associated with locating and retrieving the documents, thereby promoting customer 22 and customer service representative 18,20 convenience and efficiency. This advantage may be realized where, for example, the product information pertains to construction products, for which an enterprise generates technical documents and receives regulatory approval documents. This advantage may be particularly evident where technical service representatives 18 need to locate and retrieve both technical and regulatory approval documents in order to provide customers 22 with engineering judgments. In some embodiments, customers 22 may be provided with direct access to the documents on a self-service basis, offering added convenience to customers and reducing the burden on enterprise of providing customers 22 with such documents. Additionally, the storage of such documents centrally in file archive 24 may advantageously allow system 10 to deliver technical service representatives 18, sales representatives 20, and customers 22 current product information, and may be used to ensure that technical service representatives 18, sales representatives 20, and customers 22 receive consistent product information by virtue of accessing a single information set.

Moreover, the way in which such documents within the file archive 24 are organized and presented to customer service representatives 18,20 and customers 22 may further reduce the time and difficulty involved in locating and retrieving such documents. For example, information describing the documents stored in the file archive may be stored in database 26 and used to allow customer service representatives 18,20 and customers 22 to locate documents. Menus, indexes, or tables of contents may be provided that enable customer service representatives 18,20 and customers 22 to more quickly and easily locate and retrieve documents. Further, administrators 16 may organize documents within files such that a particular document within the file may be more quickly and easily located.

As mentioned above, system 10 manages contact information and correspondence for, and delivers announcements to customer service representatives 18,20. Network server 14 may store contact information received from customer service representatives 18,20 in database 26, and customer service representatives 18,20 may perform searches for information for a specific contact stored within database 26, as will be describe in greater detail below. The central management of contact information may advantageously allow such customer service representatives 18,20 to share contact information, and may ensure that all customer service representatives 18,20 have access to updated contact information received by one such customer service representative 18,20.

As will be described in greater detail below, network server 14 may store correspondence generated by customer service representatives 18,20 in file archive 24, and information describing correspondence in database 26. The central management of correspondence may advantageously allow customer service representatives 18,20 to maintain a log of correspondence generated and search that log to retrieve previously correspondence. This may allow customer service representatives 18,20 to keep accurate records of correspondence drafted, and use previously drafted correspondence as a reference when drafting new correspondence. Further, network server 14 may advantageously assist customer service representatives 18,20 in generating correspondence by providing customer service representatives 18,20 with templates based on user information and contact information, as will be described in greater detail below.

As will be described in greater detail below, network server 14 may store announcements in file archive 24, and may provide the announcements to intended customer service representatives 18,20. The announcements may contain information that the enterprise wishes to bring to the attention of such customer service representatives 18,20, such as changes in the product information available from system 10, the occurrence of sales promotions, or the like. System 10 may advantageously provide a means to deliver such announcements to customer service representatives 18,20.

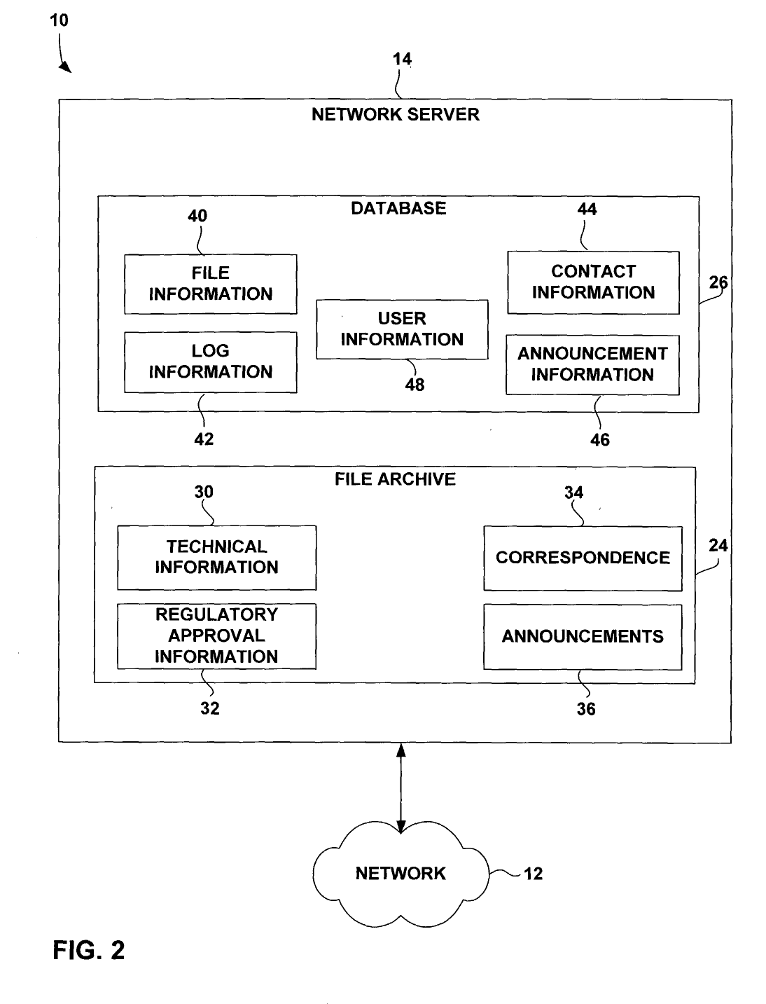

FIG. 2 is a block diagram illustrating system 10 in greater detail. In particular, FIG. 2 illustrates the types of files that network server 14 may store within file archive 24, and the types of information that network server 14 may store within database 26. As shown in FIG. 2, file archive 24 may include files containing technical information 30, regulatory approval information 32, correspondence 34 generated by technical service representatives 18 and sales representatives 20, and announcements 36 to be delivered to such customers service representatives 18,20. File archive 24 may also include files containing additional categories of information, such as marketing information. As shown in FIG. 2, database 26 may include file information 40 that describes technical information 30 and regulatory approval information 32 stored within file archive 24, log information 42 that describes correspondence 34 stored within file archive 24, contact information 44 for the various customers 22 and other contacts of customer service representatives 18,22 announcement information 46 that indicates to whom announcements 36 should be delivered, and user information that describes the various users 16-22.

As described above, technical information 30 may include product specifications and product use and installation instructions, application and design notes, and the like generated by an enterprise. As described above, regulatory approval information 32 may include test results and approval letters received by the enterprise, and documents maintained by the enterprise that describes the standards and regulations that apply to products that the enterprise manufactures and/or sells. Further, as described above administrators 16 may direct network server to store one or more such documents as a file in file archive 24. The files containing technical information 30 and regulatory approval information 32 may be word processing files, postscript data files, HTML files, XML files, or the like. By the storing the documents that contain product information centrally in file archive 24, system 10 may advantageously make it less difficult and time consuming for technical service representatives 18, sales representatives 20, and customers 22 to locate and retrieve the documents.

As mentioned above, administrators 16 may organize technical information 30 and regulatory approval information 32 within files such that a particular document within the file may be more quickly and easily located. For example, administrators 16 may create a single file, such as a postscript data file, containing multiple documents, where the file includes a table of contents, index, or nested indexes that link to specific documents in the file. Administrators 16 may then direct network server 14 to store this file in file archive 24 for later retrieval by technical service representatives 18, sales representatives 20, and customers 22.

The arrangement of technical information 30 and regulatory approval information 32 in files in the manner may advantageously allow technical service representatives 18, sales representatives 20, and customers 22 to more quickly locate a particular document in the file. Further, the arrangement of documents in files in the manner and may advantageously present the documents in the fashion that such users are accustomed to. For example, technical service representatives 18 and sales representatives 20 may, for example, be accustomed to locating a document describing a regulation in a tabbed binder of regulations. Administrators 16 may create a file that replicates the tabbed binder of regulations that technical service representatives 18 and sales representatives 20 may retrieve from network server 14.

As mentioned above, administrators 16 may provide file information 40 that describes the various technical information 30 or regulatory approval information 32 within each file. Network server 14 may store file information 40 in database 26. File information 40 for a file may include document types, e.g., specification, use or installation instructions, test result, approval letter, regulation, or the like. File information 40 for a file may also identify the one or more products, regulations, standards, or class of products, regulations, or standards to which the technical information 30 or regulatory approval information 32 within that file pertain or are related. File information 40 may be maintained as a table of records within database 26, with a record for each file stored in file archive 24. The record may also identify the location of the file within file archive 24. Categories of file information 40, such as document types, products, regulations, standards, classes of products, and the like, may correspond to fields within the records. Network server 14 may compare file information 40 to selections within menus, indexes, or tables of contents within a user interface provided by a network client device made by technical service representatives 18, sales representatives 20, and customers 22 to more quickly and easily locate and retrieve documents for such users.

As mentioned above, system 10 may also manage contact information 44 for technical service representatives 18 and sales representatives 20. Contact information 44 may include names, company names, addresses, telephone and facsimile numbers, email address, and the like for contacts of customer service representatives 18,20. Network server 14 may store contact information 44 within database 26 as a table of records, wherein each record corresponds to a contact. The fields of each record may include name fields, company name fields, addresses fields, telephone and facsimile number fields, email address fields, and the like. The record may also indicate the customer service representative 18,20 who created the record. Customer service representatives 18,20 may interact with network server 14 via a user interface provided by a network client device to create records containing contact information, to retrieve particular records, and to modify the records as necessary, as will be described in greater detail below. As mentioned above, the central management of contact information may advantageously allow such customer service representatives 18,20 to share contact information, and may ensure that all customer service representatives 18,20 have access to updated contact information received by one such customer service representatives 18,20.

As mentioned above, system 10 may also manage correspondence 34 for customer service representatives 18,20. Network server 14 may store correspondence 34 generated by customer service representatives 18,20 within files in file archive 24. The files may be word processing files, or the like.

When customer service representatives 18,20 generate correspondence 34, the customer service representatives 18,20 may provide log information 42 that describes correspondence 34 to network server 14 via a user interface provided by a network client device. Log information 42 provided by customer service representatives 18,20 for a particular file within correspondence 34 may include an author, recipient, a category, such as general sales, technical support, or engineering judgment, a subject, products or regulations to which the correspondence 34 relates, a date the correspondence 34 was created, an indication as to whether the correspondence 34 has been delivered, any notes the author may wish to include, and the like. Network server 14 may maintain log information 42 within database 26 as a table records, with a record for each file stored as correspondence 34 in file archive 24. Fields within each record may correspond to the types of log information 42 described above. A record may also include a location of the particular file within file archive 24.

Log information 42 may allow customer service representatives 18,20 to maintain a log of correspondence 34 generated, and search for particular correspondence 34 within file archive 24 based on log information 42. This may allow customer service representatives 18,20 to keep accurate records of correspondence 34 drafted, and use previously drafted correspondence 34 as a reference when drafting new correspondence. Further, network server 14 may advantageously assist customer service representatives 18,20 in generating correspondence by providing customer service representatives 18,20 with templates based on log information 42 provided by the customer service representatives 18,20, as will be described in greater detail below.

Announcements 36 are files within file archive 24 that contain information that the enterprise wishes to bring to the attention of customer service representatives 18,20, such as changes or additions to technical information 30 or regulatory approval information 32, the occurrence of sales promotions, or the like. Announcements 36 may be word processing files, postscript data files, HTML files, XML files, or the like. Administrators 16 may provide network server 14 with announcements 36, and direct network server 14 to store announcements 36 in file archive 24 for later retrieval by technical service representatives 18 and sales representatives 20 via a user interface provided by a network client device.

Administrators 16 may also provide network server 14 with announcement information 46 that describes announcements 36, and direct network server 14 to store announcement information 46 in database 26. Announcement information 46 may include subjects of announcements 36 and recipients of announcements 36. Network server 14 may maintain announcement information 46 within database 26 as a table records, with a record for each announcement 38 stored in file archive 24. Fields within each record may correspond to the types of announcement information 46 described above. Each record may also include the location of an associated announcement 38 within file archive 24. Network server 14 may use announcement information 46 to provide the announcements to intended customer service representatives 18,20, as will be described in greater detail below.

Administrators 16 may also provide network server 14 with user information 48 that describes the various users 16-22 of system 10, and direct network server 14 to store user information 48 in database 26. User information 48 may be stored as a table of records, with each record corresponding to a user. User information 48 may include contact information for the user. Network server 14 may use the contact information within user information 48 to generate templates to assist customer service representatives 18,20 in the generation of correspondence 34.

User information 48 may also include user identifications and passwords, or the like, and may indicate the type of user 16-22 that each user 16-22 is. Access to system 10 may be controlled by user identification and passwords. Use of user identification and passwords may protect the information within file archive 24 and database 26 from access by unauthorized non-users.

Further, in some embodiments, user identification and passwords may be used to control or identify the level of access to the functionality provided by network server 14 to be provided to a particular user 16-22. For example, when a user 16-22 provides a user identification and a password to network server 14 via a user interface provided by a network client device, network server 14 may locate the record within user information 48 that contains that user identification and password to identify the type of user 16-22 that the particular user 16-22 is. Network server 14 may make portions of the functionality provided by network server 14 unavailable based on the type of user 16-22 identified. Thus, when technical service representatives 18 or sales representatives 20 log on to system 10, network server 14 may cause functionality associated with administrators 16, such as the ability to modify technical information 30 and regulatory approval information 32 within file archive 24, to be unavailable. Similarly, when customers 22 log on to system 10, network server 14 may additionally cause functionality associated with technical service employees 18 and sales representatives 20, such as access to the contact information, correspondence, and announcement functions provided by network server 14, to be unavailable. Network server 14 may control the functionality level by directing the client device to change the user interface by, for example, graying out certain portions of the user interface, or by providing different web pages to the client device for display using a web browser.

In some embodiments, customers 22 will not be users of system 10 in the sense that user information 38 will not include information describing customers 22, and customers 22 will not access system 10 using user identifications and passwords. In these embodiments, customers 22 may simply be provided a level of access to network server 14 that is available to the public, which may allow customers 22 to retrieve technical information 30 and regulatory approval information 32 via a web browser.

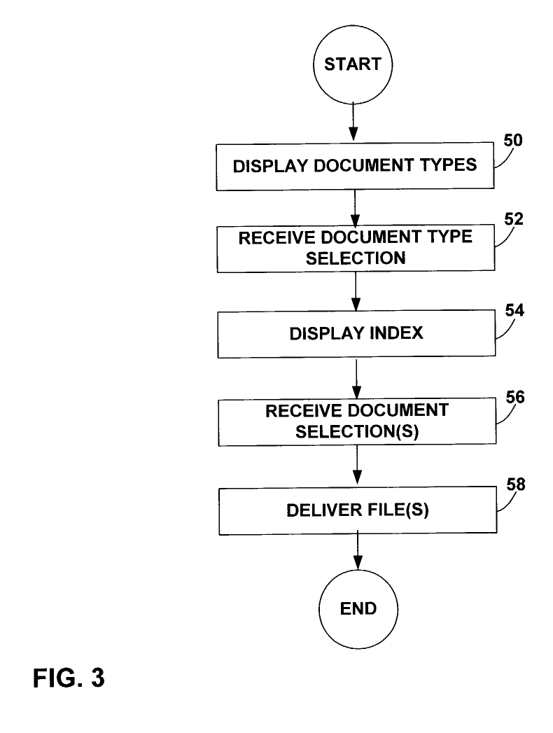

FIG. 3 is a flow diagram illustrating an example method of providing product information to technical service representatives 18, sales representatives 20, and customers 22. According to this method, network server 14 may interact with network client devices to provide technical service representatives 18, sales representatives 20, and customers 22 a user interface that contains links to technical information 30 and regulatory approval information 32 stored in file archive 24. The user interface may provide these links via a series of menus, indexes, tables of contents, or the like, which these users of system 10 may use to locate one or more documents for retrieval. Selections made by network clients 18-22 within one menu, index, or table of contents, may lead to a further menus, indexes, or table of contents, until a document is selected. Technical service representatives 18, sales representatives 20, and customers 22 may make selections by, for example, highlighting and clicking selections with a pointing device such as a mouse. In some embodiments, the menus, indexes, or table of contents provided, and the available selections within menus, indexes, or table of contents may correspond with fields of file information 40 records maintained within database 26 and the information therein. In these embodiments, network server 14 may compare the selections made by technical service representatives 18, sales representatives 20, and customers 22 to file information 40 in order to generate subsequent menus, indexes, or tables of contents. In other embodiments, the menus indexes and tables of contents may not be generated with reference to file information 40, and selections made by technical service representatives 18, sales representatives 20, and customers 22 may map to predetermined subsequent menus, indexes, or tables of contents.

For example, network server 14 may interact with a client device to provide technical service representatives 18, sales representatives 20, and customers 22 with an initial menu that lists types of documents, e.g., specification, use or installation instructions, test result, approval letter, regulation, standard, or the like (50). As mentioned above, the user interface may present technical service representatives 18, sales representatives 20, and customers 22 with a graphical depiction of a desktop, and may depict links to technical information 30 and regulatory approval information 32 stored in file archive 24 as books located on the desktop. The books located on the desktop may correspond to document types. Network server may receive a document type selection made by the client 18-22 (52), such as specifications, and based on the selected document type, network server 14 may display an index of documents within that type (54), such as a list of products for which specifications are stored in file archive 24. Intermediate menus may be provided to break the indexes into smaller groupings of documents, such as a menu that breaks the specifications into classes of products.

Displaying links in this manner may advantageously present technical service representatives 18, sales representatives 20, and customers 22 with technical information 30 and regulatory approval information that is categorized in the manner that such technical service representatives 18, sales representatives 20, and customers 22 are accustomed to. For example, customer service representatives 18,20 may be accustomed to retrieving product information from various binders, where each binder contains a document type, and further contains indexes, menus, or a table of contents that direct customer service representatives 18,20 to a particular document.

Network server 14 may receive one or more document selections from within the index (56), and deliver the files containing the selected documents to the client device associated with requesting client via network 12 (58). When a network client associated with a requesting client receives a file from network server 14 via network 12, the client device may open the file with an appropriate software package to display the one or more requested documents. The requesting client may then view the documents, print the documents, attach the documents to correspondence, or the like.

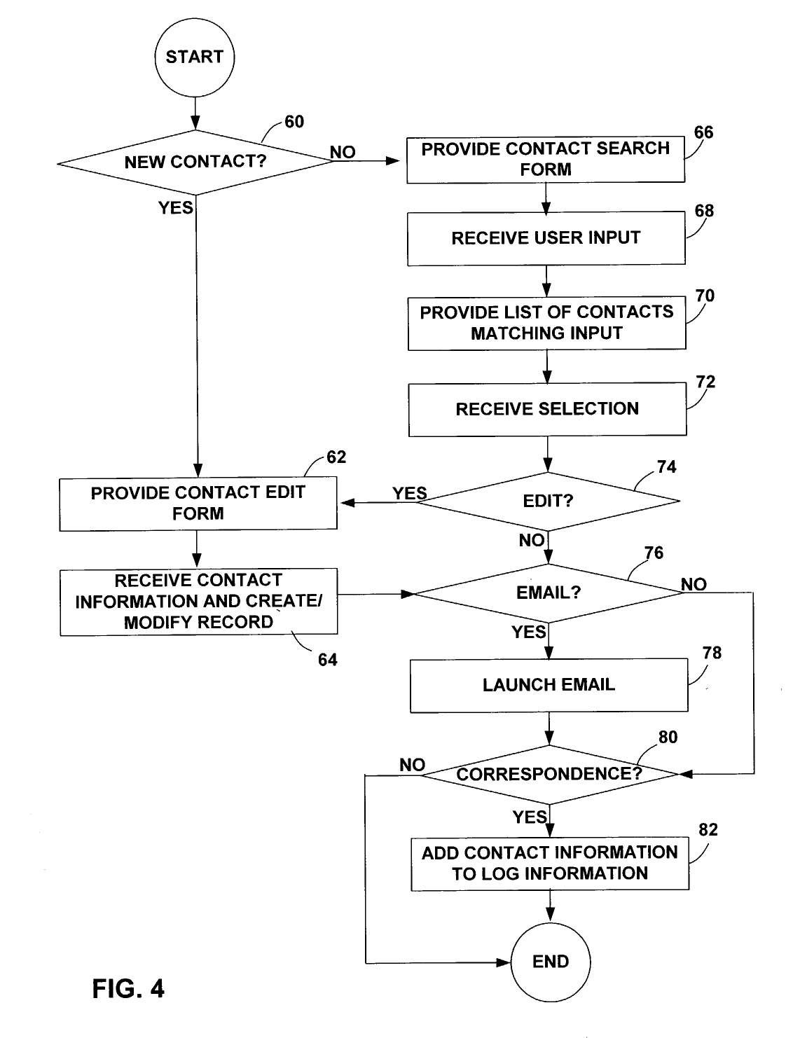

FIG. 4 is a flow diagram illustrating an example method for managing contact information 44 for technical service representatives 18 and sales representatives 20. As discussed above, contact information 44 may include names, addresses, telephone and facsimile numbers, email address, and the like, and may be stored within per-contact records in database 26. As mentioned above, the central management of contact information may advantageously allow technical service representatives 18 and sales representatives 20 to share contact information, and may ensure that all customer service representatives 18,20 have access to updated contact information received by one such customer service representatives 18,20.

Customer service representatives 18,20 may interact with network server 14 via the user interface provide by network client devices to add contact information 44 for new contacts to database 26. If network server 14 determines that a customer service representative 18,20 wishes to add a contact (60), e.g., based on selections made by the customer service representative 18,20 within the user interface, network server 14 may provide the customer service representative 18,20 with a contact edit form via the user interface (62). Network server 14 may receive contact information 44 entered into fields of the contact edit form, and create a record for the new contact within database 26 containing the contact information 44 received (64). The fields of the contact edit form may correspond to the fields of the record.

Customer service representatives 18,20 may also interact with network server 14 to search for contact information 44 within database 26 for existing contacts, and retrieve the contact information 44. Network server 14 may provide a technical services employee 18 or sales employee 20 with a contact search form via the user interface (66). Network server 14 may receive the information entered into various fields of contact search form by the customer service representative 18,20 (68), and compare the information to contact information 44 stored in database in order to provide the customer service representative 18,20 with a list of contacts that match the information provided by the customer service representative 18,20 (70). The fields of the contact search form may correspond to the fields of the records containing contact information 44 within database 26. The contact information 44 for each contact may be displayed, or the customer service representative 18,20 may select a contact for display, editing, or other further action. Network server 14 may receive the selection (72).

The customer service representative 18,20 may indicate to network server 14 whether the customer service representative 18,20 wishes to edit a selected contact (74). If the customer service representative 18,20 wishes to edit a selected contact, network server 14 may provide the contact edit form (72), as described above. However, in this case, the contact edit form provided will include the contact information 44 for the selected contact that is currently stored in database 26. The customer service representative 18,20 may add to, delete, or otherwise modify the displayed contact information 44. Network server 14 may receive these modifications and modify the record for the selected contact in database 26 to include the modifications (74). As mentioned above, the record for each contact may include an indication as to the particular customer service representative 18,20 that generated the record. In some embodiments, it may be desirable to restrict editing of a contact record to the customer service representative 18,20 that generated the record.

The customer service representative 18,20 may also indicate to network server 14 whether the customer service representative 18,20 wishes to send an email to a newly added or selected contact (76). If the customer service representative 18,20 wishes to email the contact, network server 14 may cause a network client device associated with the customer service representative 18,20 to launch an email program, if it is not already running on the network client, and create a new blank message addressed to the email address of the contact indicated within the record (78).

In some cases, the customer service representative 18,20 may have been prompted to add a new contact or search for an existing contact when attempting to generate correspondence 34 to the contact. If the customer service representative 18,20 is attempting to generate correspondence 34 (80), network server 14 may add the contact information 44 for the newly added or selected contact to log information 42 for the correspondence 34, collect additional log information for the correspondence 34, and generate a template using the log information 42 including the contact information 44, as will be described in greater detail below (82).

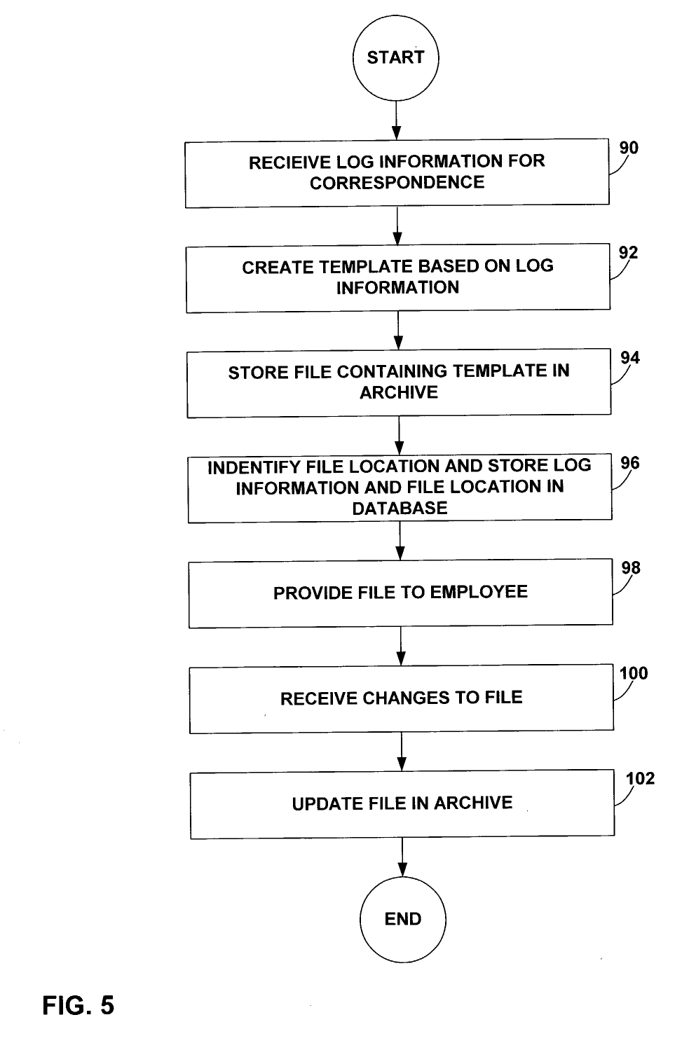

FIG. 5 is a flow diagram illustrating an example method for managing correspondence 34 for technical service representatives 18 and sales representatives 20. As mentioned above, network server 14 stores correspondence 34 generated by technical service representatives 18 and sales representatives 20 in file archive 24, and log information 42 describing correspondence 34 in database 26. Correspondence 34 generated by technical service representatives 18 and sales representatives 20 may be stored within files in database 26. The files may be word processing files, or the like.

As mentioned above, the central management of correspondence 34 and use of log information 42 may advantageously allow customer service representatives 18,20 to maintain a log of correspondence 34 generated, and search that log to retrieve previously generated correspondence 34. This may allow customer service representatives 18,20 to keep accurate records of correspondence 34 drafted, and use previously drafted correspondence 34 as a reference when drafting new correspondence 34. Further, network server 14 may advantageously assist customer service representative 18,20 in generating correspondence 34 by providing customer service representatives 18,20 with templates based on user information 48 and contact information 46, as will be described in greater detail below.

A customer service representative 18,20 may indicate to network server 14 that the employee 18,20 wishes to generate correspondence 34 via the user interface provided by network client. Network server 14 may cause the user interface to display a form used by network server 14 to collect log information 42 that describes the correspondence 34 to be generated from customer service representatives 18,20. As mentioned above, the log information 42 collected from customer service representatives 18,20 using the form may include an author, recipient, recipient company, a category, such as general sales, technical support, or engineering judgment, a subject, products or regulations to which the correspondence 34 relates, a date the correspondence 34 was created, an indication as to whether the correspondence 34 has been delivered, any notes the author may wish to include, and the like. The fields of the log information 42 form may correspond to these types of log information 42. Although the customer service representative 18,20 may be prompted to identify itself as the author in the form, in some embodiments this is not necessary as network server 14 may identify the customer service representative 18,20 based on a login. Further, when the customer service representative 18,20 is prompted to identify the recipient, the customer service representative 18,20 may be prompted to add a new contact to, or search for an existing contact within contact information 44, as described above.

When network server 14 receives the log information 42 provided by the customer service representative 18,20 (90), network server 14 may create a template based on the log information 42 (92). For example, network server 14 may retrieve the contact information for the customer service representative 18,20, i.e., the author provided as log information 42, from user information 48 stored in database 26, and use the contact information to provide a return address for the template. Network server 14 may further use contact information 44 stored in database 26 for the recipient provided as log information 42 to provide an inside address for the template, and the subject provided as log information 42 as a subject line for the template. Network server 14 may also use a document type to provide other template features, such as standardized text, specialized graphics, or macros that are used by the enterprise for that type of correspondence 34. Network server 14 may then generate a file for the correspondence 34, such as a word processing file, containing the template, and store the file in file archive 24 (94). Network server 14 may receive the location of the file within file archive 24, and create a record in database 26 for the correspondence 34 that includes the log information 42 received from the customer service representative 18,20 and the file location (96).

Network server 14 may then provide the file to the customer service representative 18,20 by, for example, delivering the file to a network client associated with the customer service representative 18,20 and directing the network client to open the file using a word processing program provided by the network client (98). The customer service representative 18,20 may then make changes to the file. When the customer service representative 18,20 saves changes to the file, network server 14 may receive the changes (100), access the file stored in file archive 24, and update the file in file archive 24 to include the changes (102).

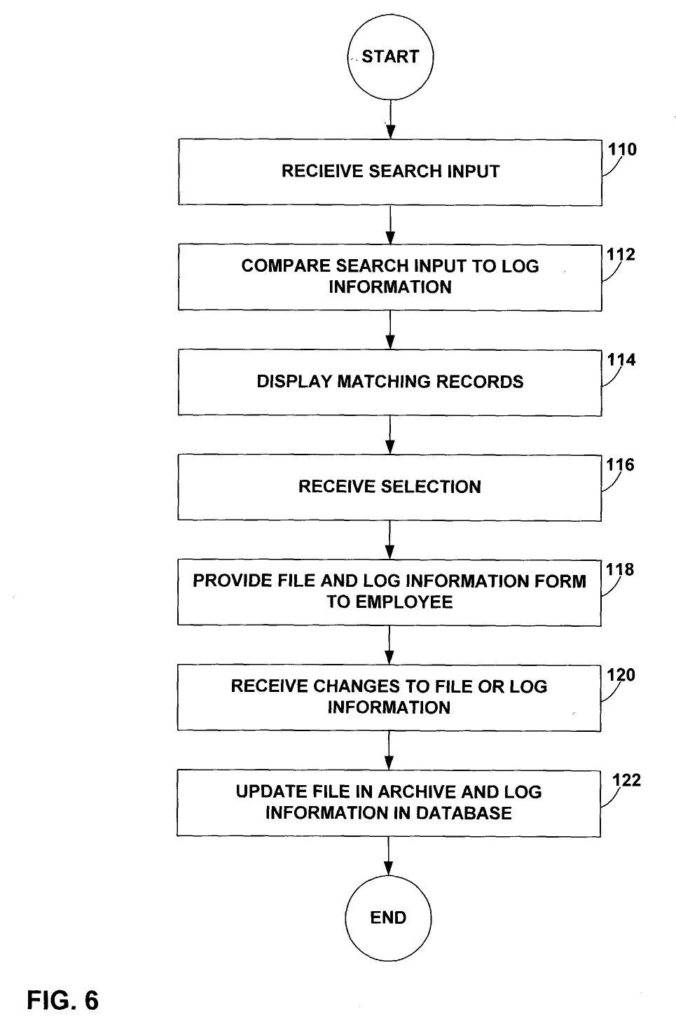

FIG. 6 is a flow diagram further illustrating the example method for managing correspondence of FIG. 5. Technical service representatives 18 and sales representatives 20 may also interact with network server 14 to search within log information 42 to identify previously generated correspondence 34. When a customer service representative 18,20 indicates a desire to search previously generated correspondence 34, network server 14 may cause a user interface provided by a network client associated with the customer service representative 18,20 to display a correspondence search form. The correspondence search form may allow the customer service representative 18,20 to search for correspondence 34 whose associated records within log information 42 have fields that match a value or term provided by the customer service representative 18,20 for those fields. For example, the correspondence search form may allow the customer service representative 18,20 to search for all correspondence 34 with the recipient value “John Smith.”

Thus, when network server 14 receives the search input provided by the customer service representative 18,20 via network 12 (110), network server 14 may compare the search input to log information 42 (112) by comparing the search input to values within fields of log information 42 records stored in database 26. Network server 14 may cause the user interface to display a listing of matching records (114) wherein each entry on the list may, for example, include one or more of the values within the fields of that record. Customer service representatives 18,20 may advantageously keep track of correspondence generated and prepare reports detailing correspondence generated using the listing provided by network server 14. For example, a customer service representative 18,20 may use a listing of all correspondence 34 with the recipient value “John Smith” as a report of all correspondence 34 sent to John Smith.

Customer service representatives 18,20 may also select a record within the list in order to review or modify the correspondence 34 associated with that record. When network server 14 receives such a selection from a customer service representative 18,20 (116), network server 14 may retrieve the location of the associated correspondence 34 within file archive 24 from the record, and retrieve the file containing the correspondence 34. Network server 14 may provide the file that contains the correspondence 34 and the log information form that contains the log information 42 currently stored in database 26 for the correspondence 34 to the customer service representative 18,20 via network 12 and a network client device associated with the customer service representative 18,20 (118). The customer service representative 18,20 may make changes to the correspondence 34, or to the log information 42 for the correspondence 34, such as changing the log information 42 to indicate that the correspondence 34 has been delivered. When network server 14 receives such changes (120), network server 14 may access the file stored in file archive 24 and update the file in file archive 24 to include the changes, or make the changes to the record stored in database 26 (122).

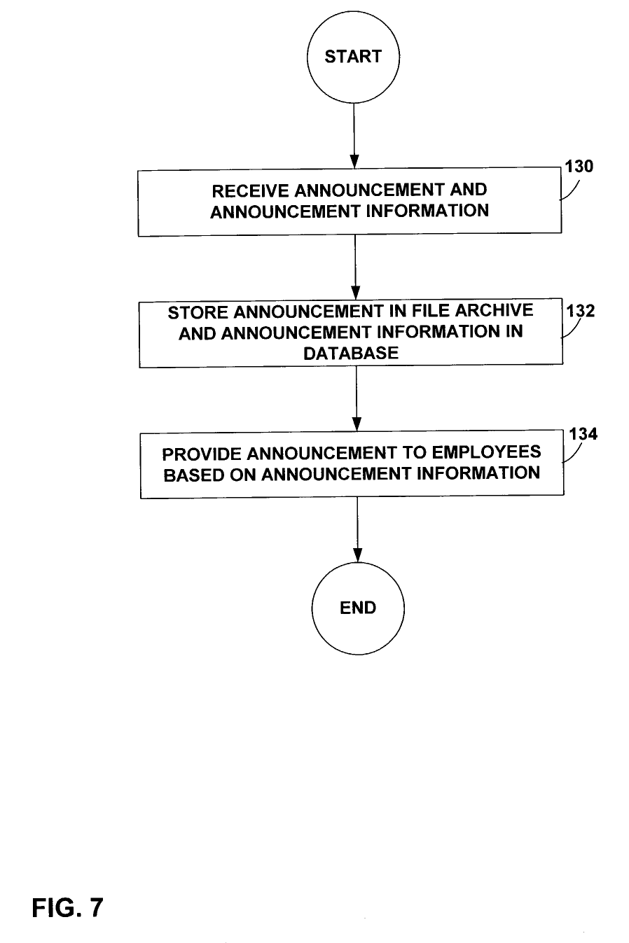

FIG. 7 is a flow diagram illustrating an example method for delivering announcements 36 to technical service representatives 18 and sales representatives 20. As discussed above, announcements 36 are files within file archive 24 that contain information that the enterprise wishes to bring to the attention of technical service representatives 18 and sales representatives 20, such as changes or additions to technical information 30 or regulatory approval information 32, the occurrence of sales promotions, or the like. Administrators 16 may provide network server 14 with announcements 36, and direct network server 14 to store announcements 36 in file archive 24 for later retrieval by customer service representatives 18,20. Administrators 16 may also provide network server 14 with announcement information 46 that describes announcements 36, and direct network server 14 to store announcement information 46 in database 26 as per announcement records, as described above. Announcement information 46 may include subjects of announcements 36 and an indication as to the customer service representatives 18,20 who are to receive announcements 36. Individual customer service representatives 18,20, or classes of customer service representatives 18,20, such as technical service representatives 18 or sales representatives 20 may be indicated.

When network server 14 receives announcements 36 and corresponding announcement information 46 from an administrator 16 (130), network server 14 may store announcements 36 in file archive 24, receive the location of announcements 36 within file archive 24, and create a records for each of announcements 36 in database 26 that include announcement information 46 and the locations of announcements 36 (132). Network server 14 may then deliver announcements 36 to customer service representatives 18,20 based on announcement information 46.

For example, network server 14 may deliver new announcements 36 to customer service representatives 18,20 indicated by the associated announcement information 46 as soon as the customer service representatives 18,20 provide a login to network server 14. Network server 14 may identify to which customer service representatives 18,20 announcements 36 have been delivered by modifying the recipient information stored as announcement information 46 for announcements, e.g., removing the recipient, after announcements 36 have been delivered. In some embodiments, network server 14 may cause the user interface provided by a network client device to present customer service representatives 18,20 with a listing of announcements pending for those customer service representatives 18,20. The listing may include subject information for each announcement 38 that was included in the announcement information 46 for that announcement 38. Customer service representatives 18,20 may select an announcement 38 from the list, and network server 14 may deliver the selected announcement 38.

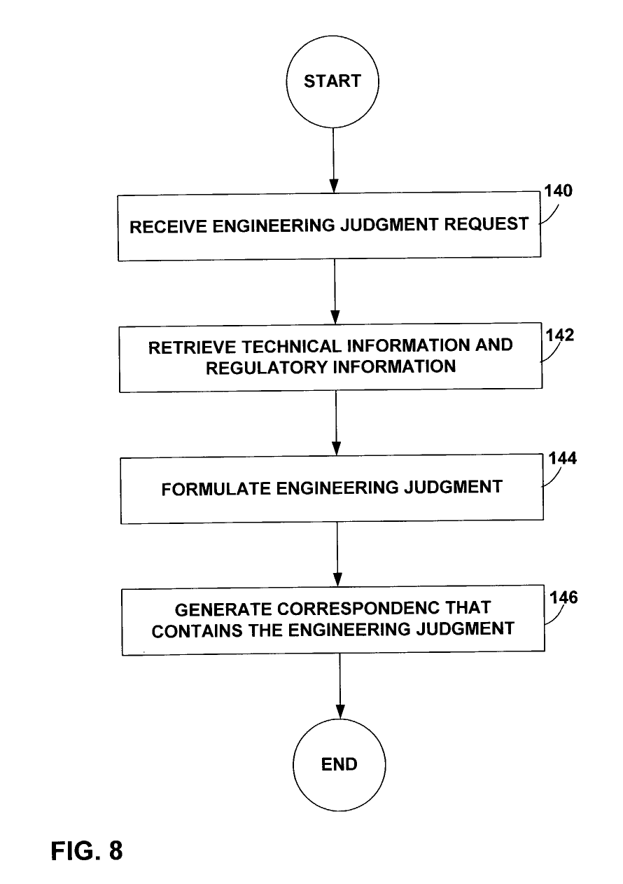

FIG. 8 is a flow diagram illustrating an example method by which technical service representatives 18 may generate engineering judgments. Technical service representatives 18 may receive engineering judgment requests for construction applications from customers 22 (140). Technical services representatives 18 may receive these requests, for example, via mail, fax, phone, email, or the like. In some embodiments, customers 22 may submit engineering judgment requests via a user interface provided by network clients associated with customers 22 and network 12, and network server 14 may present received requests to technical services representatives 18 via network clients associated with technical services representatives 18 and network 12.

Based on the construction application described, technical services representatives 18 may use the user interface provided by network clients to interact with network server 14 and retrieve technical information 30 and regulatory approval information 32 from file archive 24, as described above (142). Based on the technical information 30 and regulatory approval information 32 retrieved, technical services representatives 18 may formulate engineering judgments, i.e., judgments as to the proper usage of enterprise products for the described application in light of the applicable regulations and standards (144). Technical service representatives 18 may then generate correspondence 34, as described above, which contain the engineering judgments (146). The templates provided by network server 14 for correspondence 34 that contains engineering judgments may contain standardized text, specialized graphics, or macros that are specific for that type of correspondence 34.

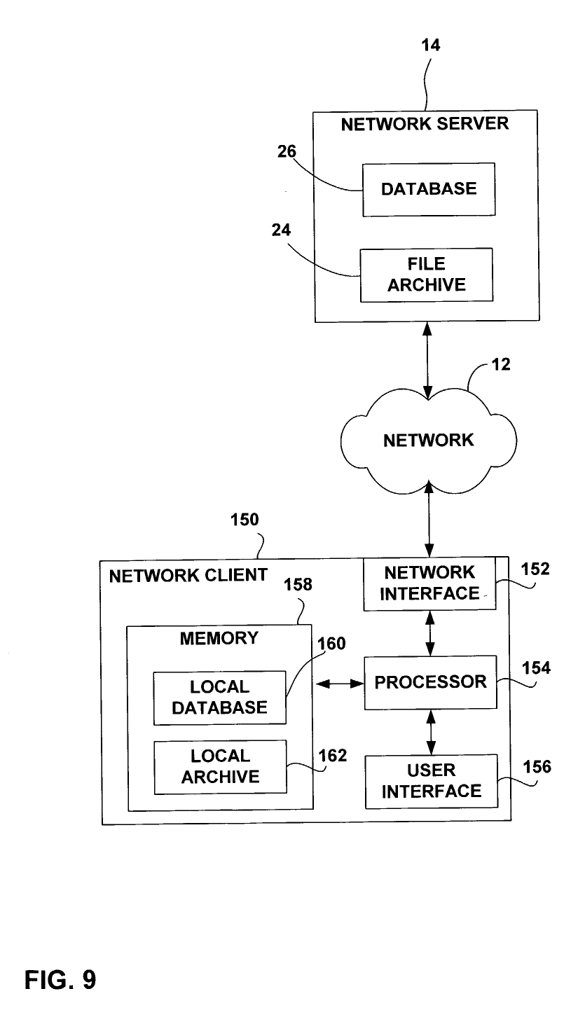

FIG. 9 is a block diagram further illustrating system 10. In particular, FIG. 9 illustrates a client device 150, which may be used by users 16-22 to interact with network server 14 in some embodiments of the system 10. As shown in FIG. 9, client device 150 includes a network interface 152, by which a processor 154 accesses network 12 to interact with network server 14. Client device 150 may also provide a user interface 156, and include a memory 158. Processor 154, user interface 156 and memory 158 may be substantially the same as the processor, user interface and memory of the client devices described with reference to FIG. 1.

However, as shown in FIG. 9, memory 158 may further include a local archive 160 and local database 162, and processor 154 may provide additional functionality to users 1622, as will be described below. Memory 158 may include any fixed or removable magnetic or optical computer-readable media, such as magnetic tapes, magnetic disks, or optical disks. Processor 154 may execute instructions embodied in application software to interact with and access resources provided by network server 14.

In embodiments of system 10 where users 16-22 use clients 150 to interact with network server 14, processor 154 may interact with network server 14 via network 12 to replicate some or all of the files within file archive 24 to local archive 160, and some or all of the records within database 26 to local database 162. When a connection with network server 14 via network 12 is available, a user 16-22 utilizing network client 150 may interact with network server 14 via processor 154 and user interface 156 to retrieve technical information 30 and regulatory approval information 32, manage contact information 44, manage correspondence 34, and receive announcements 36 as described above. However, when a connection with network server 14 via network 12 is unavailable or undesirable, processor 154 may instead interact with local archive 160 and local database 162 to allow the user 16-22 to retrieve technical information 30 and regulatory approval information 32, manage contact information 44, manage correspondence 34, and receive announcements 36. Processor 154 may interact with local archive 160 and local database 162 in the same manner that network server 14 was described as interacting with file archive 24 and database 26 above. Embodiments of system 10 that include network client 150 may provide advantages to users 16-22 by allowing users 16-22 to retrieve technical information 30 and regulatory approval information 32, manage contact information 44, manage correspondence 34, and receive announcements 36 in the absence of a network connection, such as when users 16-22 are traveling.

During periods where a user 16-22 interacts with local archive 160 and local database 162 via user interface 156 and processor 154, the user 16-22 may add files to or modify files within local archive 160, and add records to or modify records within local database 162. Further, during these periods, other users 16-22 may add files to or modify files within file archive 24, and add records to or modify records within database 26. Therefore, when processor 154 establishes a connection with network server 14, i.e., when the user 16-22 associated with network client 150 provides network server 14 with a login, network server 14 may interact with processor 154 to synchronize file archive 24 and local archive 170, and synchronize database 26 and local database 172.

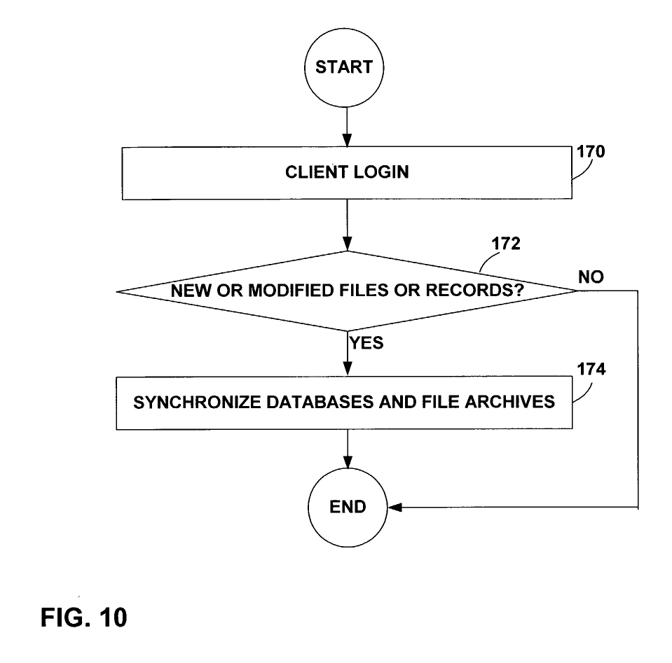

FIG. 10 is a flow diagram illustrating a method for synchronizing file archive 24 and local archive 160, and synchronizing database 26 and local database 162. When processor 154 establishes a connection with network server 14, i.e., when the user 16-22 associated with client device 150 provides network server 14 with a login (170), network server 14 may interact with processor 154 to determine whether new additions or modifications have been made to any of file archive 24, database 26, local archive 160, or local database 162 since the last time these archives and databases where synchronized (172).

For example, network server 14 or processor 154 may keep record of the last time that local archive 160 and local database 162 associated with processor 154 were synchronized with file archive 24 and database 26, and files and records within archives 24,160 and databases 26,162 may indicate the time that they were last modified. Network server 14 may interact with processor 154 to compare the last synchronization time to the last modification time of the files and records to determine which files or records within file archive 24, database 26, local archive 160, or local database 162 have been added or modified since the last synchronization time.

Network server 14 may then interact with processor 154 to synchronize archives 24,160 and databases 26,162, (174) by for example delivering the added or modified files within file archive 24 or records within database 26 to processor 154 so that processor 154 may add or modify appropriate files within local archive 160 and records within local database 162, and receiving added or modified files within local archive 160 and records within local database 162 from processor 154 so that network server 14 may add or modify appropriate files within file archive 24 or records within database 26.

Various embodiments of the invention have been described. For example, a system that allows users to retrieve construction product information from an electronic archive via network using network client devices that provide a user interface has been described. The system has also been described as allowing users to retrieve this information when a network connection is not available from a local archive on a network client device that is synchronized with the electronic archive during periods when a network connection is available. Nevertheless, various modifications may be made without departing from the spirit and scope of the invention. For example, a stand-alone embodiment of the system where product information is not retrieved via a network is contemplated. In such an embodiment, users may interact with a processor of a computing device, such as the network client devices described above, via a user interface provided by the processor of to retrieve product information that has been loaded into an electronic archive within a memory of the computing device via CD-ROM, magnetic disk, or the like. Such an embodiment may also include a database, and a user may interact with the processor to manage contact information and correspondence. These and other embodiments are within the scope of the following claims.

1. A method comprising:
storing technical information that is related to one or more construction products of an enterprise and regulatory approval information that is related to regulatory approvals of the one or more construction products in an electronic archive;
presenting a user interface containing links to the technical information and the regulatory approval information; and
permitting a user to access the technical information and the regulatory approval information via the links in the user interface.

2. The method of claim 1, wherein the electronic archive resides on a network server, and the links define network locations for the technical information and the regulatory approval information, the method further comprising permitting multiple users to access the technical information and the regulatory approval information via a network.

3. The method of claim 1, wherein the technical information includes at least one of product specifications and product use and installation instructions, and the regulatory approval information includes at least one of test results, approval letters, regulations, and standards.

4. The method of claim 1, wherein the user is at least one of a technical service representative, a sales representative and a customer.

5. The method of claim 1, wherein the technical information and regulatory approval information include files containing documents, and wherein the files include at least one of tables of contents and indexes that may be used by the user to access a selected document within the technical information and the regulatory approval information.

6. The method of claim 1, wherein permitting a user to access the technical information and the regulatory approval information comprises:
presenting at least one of a menu, an index, and a table of contents to the user via the user interface;
receiving a selection made by the user within one of the menu, index, and table of contents; and
delivering a file to the user based on the selection.

7. The method of claim 1, further comprising presenting the user interface via one of a graphical user interface and a web browser.

8. The method of claim 1, further comprising:
receiving contact information from a user via the user interface; and
storing the contact information in a database.

9. The method of claim 8, further comprising:
receiving a query from the user via the user interface;
comparing the query to records containing the contact information within the database; and
presenting a list of records via the user interface based on the comparison.

10. The method of claim 8, wherein the database resides on a network server, and receiving contact information comprises receiving contact information from multiple users via a network.

11. The method of claim 1, further comprising storing correspondence generated by the user in the archive.

12. The method of claim 11, wherein storing correspondence comprises:
receiving log information that describes the correspondence via the user interface;
creating templates based on the log information;
storing files containing the templates in the archive; and
storing the log information within a database.

13. The method of claim 12, further comprising:
providing a file containing a template to the user via the user interface;
receiving changes to the file via the user interface; and
updating the file within the archive.

14. The method of claim 12, further comprising:
receiving a query from the user via the user interface;
comparing the query to records containing the log information within the database; and
presenting a list of records to the user via the user interface based on the comparison.

15. The method of claim 12, wherein the archive and the database reside on a network server, and storing correspondence comprises storing correspondence generated by multiple users in the archive and log information that describes the correspondence generated by multiple users in the database.

16. The method of claim 1, wherein the archive and a database reside on a network server, the method further comprising:
receiving announcements and announcement information via a network;
storing the announcements in the archive;
storing the announcement information in a database; and
delivering the announcements to users via the network and the user interface based on the announcement information within the database.

17. The method of claim 1, wherein the archive and a database reside on a network server and users access the network server via network clients and a network, the method further comprising:
synchronizing a local archive within a network client and the archive that resides on the network server; and
synchronizing a local database within the network client and the database that resides on the network server.

18. The method of claim 1, wherein the user receives an engineering judgment request for a construction application from a customer, accesses the technical information and regulatory approval information to retrieve technical information and regulatory approval information for the construction application, formulates an engineering judgment based on the retrieved information, and generates correspondence for the customer that contains the engineering judgment.

19. The method of claim 1, wherein the user interface presents a graphical depiction of a desktop to the user, and depicts the links as books located on the desktop.

20. A system comprising:
an electronic archive that stores technical information that is related to one or more construction products of an enterprise and regulatory approval information that is related to regulatory approvals of the one or more construction products; and
a user interface containing links to the technical information and the regulatory approval information.

21. The system of claim 20, further comprising:
a network server containing the electronic archive; and
a network client presenting the user interface, wherein the network server delivers the technical information and the regulatory approval information to the network client via a network, and the links define network locations for the technical information and regulatory approval information.

22. The system of claim 20, wherein the technical information includes at least one of product specifications and product use and installation instructions, and the regulatory approval information includes at least one of test results, approval letters, regulations, and standards.

23. The system of claim 20, wherein the user interface presents the links to a user that is at least one of a technical service representative, a sales representative and a customer.

24. The system of claim 20, wherein the technical information and regulatory approval information include files containing documents, and wherein the files include at least one of tables of contents and indexes that may be used by the user to access a selected document within the technical information and the regulatory approval information.

25. The system of claim 20, wherein the user interface presents at least one of a menu, an index, and a table of contents to a user, receives a selection made by the user within one of the menu, index, and table of contents, and delivers a file to the user based on the selection.

26. The system of claim 20, wherein the user interface comprises one of a graphical user interface and a web browser.

27. The system of claim 20, further comprising a database, wherein the user interface receives contact information from a user and stores the contact information in the database.

28. The system of claim 27, wherein the user interface receives a query from the user, compares the query to records containing the contact information within the database, and presents a list of records to the user based on the comparison.

29. The system of claim 27, further comprising:
a network server containing the database; and
a network client presenting the user interface, wherein the network server receives contact information via the network client and a network, and stores the contact information in the database.

30. The system of claim 20, wherein the electronic archive contains correspondence generated by a user.

31. The system of claim 30, further comprising a database, wherein the user interface stores correspondence in the archive by receiving log information that describes the correspondence from the user, creating templates based on the log information, storing files containing the template in the archive, and storing the log information within the database.

32. The system of claim 31, wherein the user interface provides a file containing a template to the user, receives changes to the file made by the user, and updates the file within the archive.

33. The system of claim 31, wherein the user interface receives a query from the user, compares the query to records containing the log information within the database, and presents a list of records to the user based on the comparison.

34. The system of claim 31, further comprising:
a network server containing the electronic archive and the database; and
a network client presenting the user interface, wherein the network server receives the correspondence and the log information via the network client and a network, stores the correspondence in the archive, and stores the log information that describes the correspondence in the database.

35. The system of claim 20, further comprising:
a network server containing the electronic archive and a database; and
network clients presenting the user interface, wherein the network server receives announcements and announcement information via a network client associated with an administrator and a network, stores the announcements in the archive, stores the announcement information in the database, and delivers the announcements to network clients associated with users via the network based on the announcement information within the database.

36. The system of claim 20, further comprising:
a network server containing the electronic archive and a database; and
a network client presenting the user interface, wherein the network client includes a local archive and a local database, and the network server interacts with the network client to synchronize the local archive and the electronic archive within the network server, and synchronize the local database and the database within the network server.

37. The system of claim 20, wherein the user interface presents a graphical depiction of a desktop to a user, and depicts the links as books located on the desktop.

38. A computer-readable medium comprising instructions that cause a processor to:
present a user interface containing links to technical information that is related to one or more construction products of an enterprise and regulatory approval information that is related to regulatory approvals of the one or more construction products stored in an electronic archive; and
permit a user to access the technical information and the regulatory approval information via the links in the user interface.

39. The computer-readable medium of claim 38, wherein the electronic archive resides on a network server, and the links define network locations for the technical information and regulatory approval information, the medium further comprising instructions that cause the processor to permit multiple users to access the technical information and regulatory approval information via a network.

40. The computer-readable medium of claim 38, wherein the instructions that cause the processor to present the user interface comprise instructions that cause the processor to:
present at least one of a menu, an index, and a table of contents to the user via the user interface;
receive a selection made by the user within the at least one of the menu, the index, and the table of contents via the user interface; and
deliver a file based on the selection.

41. The computer-readable medium of claim 38, further comprising instructions that cause the processor to:
receive contact information from the user via the user interface; and
store the contact information in a database.

42. The computer-readable medium of claim 41, further comprising instructions that cause the processor to:
receive a query from the user via the user interface;
compare the query to records containing the contact information within the database; and
present a list of records via the user interface based on the comparison

43. The computer-readable medium of claim 38, further comprising instructions that cause the processor to store correspondence generated by the user in the archive.

44. The computer-readable medium of claim 43, wherein the instructions that cause the processor to store correspondence comprise instructions that cause the processor to:
receive log information that describes the correspondence via the user interface;
create templates based on the log information;
store files containing the template in the archive; and
store the log information within a database.

45. The computer-readable medium of claim 44, further comprising instructions that cause the processor to:
receive a query from the user via the user interface;
compare the query to records containing the log information within the database; and
present a list of records via the user interface based on the comparison.

46. The computer-readable medium of claim 38, wherein the electronic archive and a database reside on a network server, the medium further comprising instructions that cause the processor to:
receive announcements and announcement information via a network;
store the announcements in the archive;
store the announcement information in the database; and
deliver the announcements to user via the network and the user interface based on the announcement information within the database.

47. The computer-readable medium of claim 38, wherein the archive and a database reside on a network server and users access the network server via network clients and a network, the medium further comprising instructions that cause the processor to:
synchronize a local archive within a network client and the archive that resides on the network server; and
synchronize a local database within a network clients and the database that resides on the network server.

48. The computer-readable medium of claim 3 8, further comprising instructions that cause the processor to cause the user interface to present a graphical depiction of a desktop to a user, and depict the links as books located on the desktop.
